(19) United States
(12) Patent Application Publication
(10) Pub. No.: US 2004/0095317 A1
(43) Pub. Date: May 20, 2004

(54) Method and apparatus of universal remote pointing control for home entertainment system and computer

(76) Inventors: Jingxi Zhang, Foster City, CA (US); Yang Zhang, Foster City, CA (US); Huifang Ni, Foster City, CA (US)

Correspondence Address: JINGXI ZHANG, 1403 MELBOURNE STREET, FOSTER CITY, CA, 94404, US

(21) Appl. No.: 10/065,798

(22) Filed: Nov. 20, 2002

(51) Int. Cl. G09G 5/08

(52) U.S. Cl. 345/158

(57) ABSTRACT

A universal television and computer pointing control system is disclosed. The system is comprised of a handheld pointing device, a display control unit, and a command delivery unit. The system allows the user to simply point and click to control a computer or various home entertainment component devices remotely. Inside the handheld device, orientation sensors detect pointing direction. The pointing direction signals are transmitted to the display control unit, and a cursor (pointer) is drawn onto the screen indicating the pointer's location. By interpreting the pointing direction signals and the button activities, the display control unit issues a control signal to the command delivery unit. The command delivery unit then forwards the commands to the target device to execute the desired control function.

### BACKGROUND OF INVENTION

With advancing technology, more and more features are added to home video and audio entertainment systems. For example, interactive television sets allow users to purchase a pay program by pressing buttons on the remote control. However, the rich set of functions requires more buttons on the remote control unit. The jam-packed button layout on the remote control unit makes the handheld device bulky and complicated. Moreover, an increasing number of audio and video component devices, for example, VCRs, DVD players, digital TV set-top boxes, are added into home entertainment systems. Each device is usually controlled by a unique remote control unit. To reduce the user's confusion of multiple remote control units, universal remote control devices were introduced to consumers. The universal remote control device can be either preprogrammed or trained with other remote controls by the user to provide multi-device control functionality. However, because more functions are being added to this type of handheld device, and because of the limited number of buttons available (which are already crowding the device), each button must serve multiple functions. Unfortunately, the multi-function buttons cannot provide clear visual feedback indicating their current function. This unfriendly user interface is obscure to the user operating the remote control unit and leads to only a small subset of the functions being utilized. Furthermore, the expandability of present universal remote control devices is very poor. As new media modules are introduced into home entertainment systems, for instance, Internet browsers, it becomes even more difficult to adapt the existing universal remote control to the new requirements, in the case of Internet browsers, that users be able to move a pointer and select a visual object on the screen to operate a certain function. A handheld pointing control device is desirable in such a case. While using the pointing device, the on-screen graphical user interface (GUI) provides friendly visual feedback. The dynamically displayed selectable on-screen identifiers (menus, icons, buttons, etc.) greatly reduce the number of buttons on the pointing control device.

In the case of computer slide presentations, a convenient handheld remote pointing and control device is also considered necessary. Conventional computer control depends on keyboard and mouse which are physically bounded with computer hardware and a fixed surface such as a table. To control the flow of the presentation slides or to point out figures on the slide to the audience, the presenter is forced to stay with the computer keyboard and mouse. This constraint is very inconvenient for the presenter trying to deliver his/her talk to the audience. A remote pointing control device could help the presenter to freely walk about the stage and move a pointer on the screen to guide the audience.

Because of the need for a remote pointing mechanism for home entertainment systems and computer presentations, many methods and devices have been invented. For examples, Fan (U.S. Pat. No. 5,926,168) has described several methods, including using light emission and electromagnetic fields, to develop remote pointing devices; Kahn (U.S. Pat. No. 6,404,416) described a pointing interface for computer systems based on raster scanned light emitted from display screens. The methods presented in those inventions are complicated, and some require a new display apparatus to replace the existing one. Marsh et al. (U.S. Pat. No. 5,999,167) introduced a pointer control device based on an ultrasound source. Pilcher et al. (U.S. Pat. No. 5,359,348), Hansen (U.S. Pat. No. 5,045,843), Odell (U.S. Pat. No. 5,574,479) and King, et al (U.S. Pat. No. 4,565,999) presented pointing devices based on detecting fixed light sources. Auerbach (U.S. Pat. No. 4,796,019) explained a pointing device containing multiple light sources and the lights are detected by a fixed light sensor. Wang et al. (U.S. Pat. No. 5,126,513) suggested a pointing measurement method by detecting the wave phases from a fixed transmitter. However, in practice, all the approaches based on detecting fixed local sources suffer from the limitations of the fixed source locations and orientations, as well as the distance between the pointing device and fixed sources. Moreover, the control methods proposed in all the aforementioned inventions are limited to only a single target device. The control scope is narrow and cannot cover all the related video/audio devices or equipment.

Recently, low cost magnetic field sensors based on magneto-resistive, magneto-inductive and Hall-effect technologies were developed. Those magnetic sensors are sensitive enough to measure earth's magnetic field and are widely used in such navigational devices as digital compasses and the Global Positioning System (GPS). Some magnetic sensors are packaged to detect two-axis, even three-axis, magnetic field changes and provide a linear output to the direction of the magnetic field flux, such as HMC1052 two-axis magnetic sensor from Honeywell (www.ssec.honeywell.com). The two-axis magnetic field sensor can be easy and cost-perfect to implement a pointing device to detect the yaw (azimuth) angle relative to earth's North Pole. However, using magnetic field sensors to detect a pitch (inclination) angle change would be a problem, particularly when the pointing device's heading direction is perpendicular to earth's North-South axis. Hall et al. (U.S. Pat. No. 5,703,623) presented a pointing device using three pairs of orthogonally mounted one-axis Hall-effect sensors. To overcome the problem in measuring pitch and roll angles, a set of piezoelectric sensors is used to detect the acceleration changes. The authors suggested using the detected acceleration data to compensate the deficient of magnetic sensors. However, to measure device angular movement an integration of the acceleration steps is required. The piezoelectric sensors detect only the dynamic changes of acceleration. The acceleration measurement errors are introduced because piezoelectric sensors are failed to measure the constant acceleration. The accumulated acceleration error in the integration process would eventually render the device unusable.

To detect a pointing device's pitch and roll angles, a static accelerometer can be used. Recently, low-cost, lightweight accelerometer sensors using Micro-Electro-Mechanical Systems (MEMS) technology are available from many sources. MEMS devices integrate mechanical elements, sensors, actuators, and electronics on a common silicon substrate using micro-fabrication technology, which provides a cost-effective and small-footprint component for consumer manufactories. Two-axis linear MEMS accelerometers, such as ADXL-202E from Analog Devices (www.analog.com), LIS2L01 from STMicroelectronics (www.st.com), and MXD2010U/W from MEMSIC (www.memsic.com), can measure both dynamic and static acceleration and are good candidates for use in pointing devices to determine the pitch and roll angles. The earth's gravity exerts a constant acceleration on the MEMS accelerometer. By calculating the accelerometer's static acceleration outputs, a tilt angle (pitch or roll) can be obtained.

Besides magnetic field sensors and accelerometer sensors, gyro sensors can also be used in pointing device design. Gyro sensors, such as the ADXRS150 MEMS gyroscope from Analog Devices (www.analog.com), can detect changes in the device's orientation angle and thus can be used in detecting the pointing device's heading.

The object of the present invention is to provide a low-cost, practical, universal pointing device to control home entertainment systems and computer systems using spatial orientation sensor technologies.

### SUMMARY OF INVENTION

A universal pointing control system for televisions and computer displays is disclosed. The system is comprised of a remote handheld device, a display control unit and a command delivery unit. The remote handheld device includes a set of orientation sensors that detect the device's current orientation. In the preferred embodiment, a two-axis magnetic sensor identifies the device's azimuth angle by detecting the earth's magnetic field, and a dual-axis accelerometer sensor identifies the device's inclination angle by detecting the earth's gravity. The signals from the orientation sensors are translated and encoded into pointing direction information by a microprocessor or logic circuits on the pointing device and transmitted to the display control unit. Along with the directional information, data regarding the user's selection activities collected by a selection unit in the handheld device is also encoded and sent to the display unit. The display control unit includes a data transceiver, a CPU, and a display control circuit for interfacing target device. The pointing direction information received by the transceiver is decoded and manipulated by the on board CPU. Based on the pointing information, the CPU instructs the controlled target device interface, either a television set or a computer, to display a pointer at the corresponding coordinates on the target device screen. User selection activities are also interpreted by the CPU based on the current pointer location, and corresponding commands are sent to the command delivery unit. The command delivery unit, which can be a stand-alone device or built into the handheld pointing device, forwards the commands to any remote controllable target device using an infrared beam to execute a desired operation.

The handheld remote control device is simple and easy to use. User directly points to any position of the screen and a cursor is displayed on the screen at the pointed location. By selecting a menu or active control shape on the screen using a selection button on the device, the user can control the target device's operation intuitively. Because fewer buttons are required to operate the device (e.g. a selection button, a calibration button, and a button to show and hide the on-screen pointer), the device can be made smaller and lighter. The selectable items can vary and change their appearance dynamically based on the status of the operations. With visual feedback, the system provides a much better and friendlier graphical interface to users. Because the pointing signals are generated from the handheld remote control device without reference to any source from other devices or equipment, there is no significant change necessary on the television or computer system. In the described embodiment, the remote pointing device can be directly used in existing televisions and computers without any modification. The control scope of this system is broad enough to cover all the audio/video devices which are originally controlled by their respective remote controls. The extendibility of the system allows new types of devices to be easily adapted and controlled.

### BRIEF DESCRIPTION OF DRAWINGS

FIG. 1 is a perspective view of the universal pointing system in controlling a variety of equipments in the home entertainment system.

FIG. 2 is a perspective view of the pointing system in controlling computer presentations.

FIG. 3 shows the components in the handheld pointing device.

FIG. 4a and 4b demonstrate the principal mechanism of the orientation sensor detecting the device's orientation changes, and how the screen pointer to reflects these changes.

FIG. 5 is the functional block diagram of the pointing device.

FIG. 6a is the functional block diagram of the display control unit for a computer.

FIG. 6b is the functional block diagram of the display control unit for a home entertainment system.

FIG. 7a is the functional block diagram of the command delivery unit.

FIG. 7b shows the command delivery unit being trained by an original remote control.

FIG. 8a is the alternative functional block diagram of the display control unit which includes the remote control training circuit.

FIG. 8b shows the display control unit being trained by an original remote control.

### DETAILED DESCRIPTION

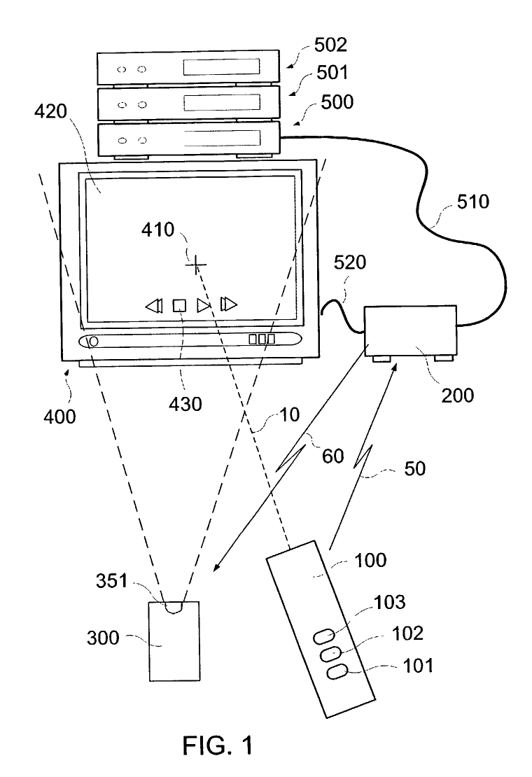

The present invention's universal pointing control system consists of a handheld pointing device 100, a display control unit 200 and a command deliver unit 300 as shown in FIG. 1. In this example, the display control unit 200 is connected to a television 400 and a video component device 500, which can be a digital TV set-top box, a VCR, or a DVD player, through video cables 520 and 510, respectively. The display control unit 200 can also be embedded inside the TV or other video component device in alternative embodiments. The handheld pointing device 100 is aimed at the television screen 420 indicated by a line of sight 10. On the other end of this line, a pointer 410 is displayed on the screen. When the user points the device to an arbitrary position of the screen, a set of orientation sensors inside the pointing device 100, which will be described in later, detects the device's current orientation and generate the pointing direction signal. The pointing direction signal is encoded and sent to the display control unit 200 through a transmission link 50. This transmission link can be any form of signal linkage. For example, it could be implemented by using radio frequency (RF) wireless link, infrared (IR) link, or even a wired cable. Upon receiving the signal, a central process unit (CPU) inside the display unit 200 decodes and analyzes the pointing direction and determines the new coordinates of the pointer on the screen. A pointer is drawn at the calculated coordinate and the pointer image is then superimposed onto the input video signal, which is input from video component device 500 through cable 570. A set of menus and control items 430 are also drawn and superimposed to the video signal. The composite video is then output to the television 400 through the output video cable 520 and displayed on the television screen 420. As a result, the pointer 470 is shown at a new location on the screen where the user points to. The user perceives that the pointer is moved following the aiming line of sight 70.

Buttons are located on the handheld pointing device to collect the user's selection activities. Three buttons are shown in this example, one for command selection (101), one to show and hide screen pointer (102), and another one for calibration purpose (703). When the user uses the device at first time, a calibration procedure is performed. The user aims the device at the center of the screen and presses button 703. The device's pointing direction information is recorded and stored into the display control unit as the screen center reference. Any subsequent pointing information is then compared with this reference, and the difference will be calculated as the pointer displacement distance away from the screen center.

During normal usage, as the user points and clicks the selection button, the on-screen menu or selectable items under the pointer are processed by the CPU in the display control unit. Selection information is generated and forwarded to the command delivery unit 300 by means of transmission link 60. The link 60, again, can be any form of signal linkage. The command deliver unit 300 can be a stand-alone device facing the TV 400 and other equipments (500,570,520), or can be embedded inside the pointing device 100. All remote control command codes for the devices in the home entertainment system are prerecorded in a memory module in the command delivery unit 300. Upon receiving selection information, the command delivery unit issues the corresponding command by searching the memory module, and emits the command infrared (IR) signal through the IR emitter 351 to the controlled equipments. The target equipment performs a task as if it had received a command directly from its original remote control device.

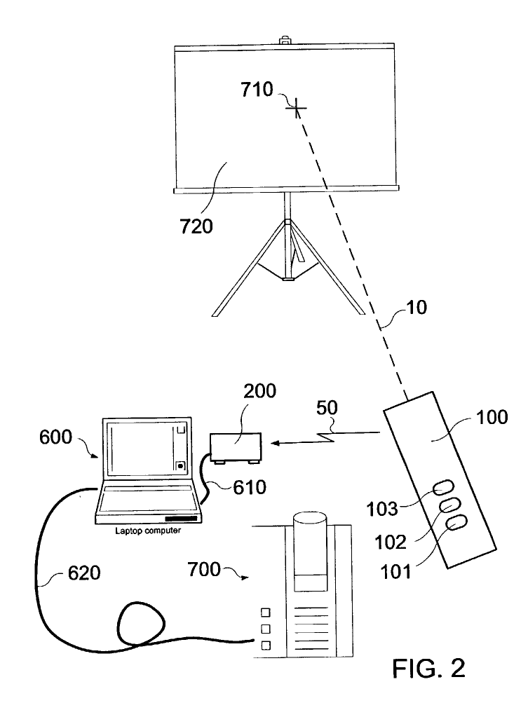

FIG. 2 shows the pointing control system as used in a computer presentation scenario. In this case, the presentation is projected onto the screen 720 by a projector 700, which receives the video input from a computer 600 though a video cable 620. The display control unit 200 is connected to the peripheral port of a computer 600 through the cable 610. The presenter aims the pointing device at the screen 720 by a line of sight 10. The aiming direction information generated by a set of orientation sensors in the pointing device 100 is transmitted to display control unit 200 through transmission link 50. The CPU in the display control unit interprets the direction information, sends the pointer move command to the computer's peripheral port, and instructs the computer to move the pointer 710 on screen to the aimed place. This is analogous to moving the pointer by moving a regular computer mouse device, except that the moving information is in absolute coordinates instead of relative steps. The buttons 101, 102, and 103 on the pointing device allow the presenter to select and execute a command remotely.

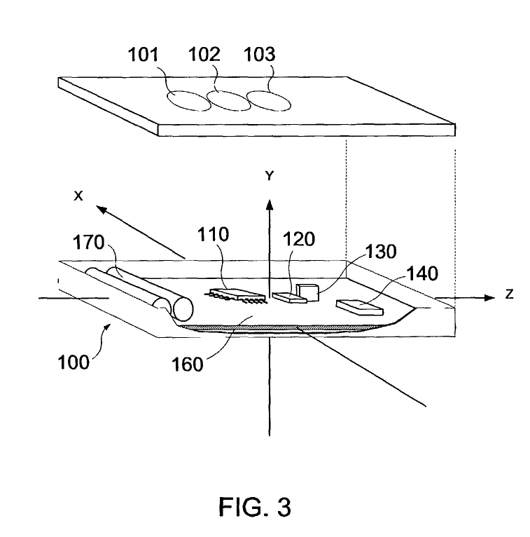

FIG. 3 exposes the components inside of the handheld pointing device. On the top face of the device are buttons 101, 102, and 103 for collecting user selection activities. A set of orientation sensors 120 and 130 mounted on the print circuit board 160 detect device's orientation changes. Note that the sensors are mounted orthogonally to each other. The sensor 120 detects the device's yaw (azimuth) angle and sensor 130 detects device's pitch (inclination) angle. Additional sensors (not show in the picture) could be used to detect device's roll angle which may provide an additional dimension of control. A microcontroller 110 provides computation power for calculating and encoding the orientation signal output from the orientation sensors. It also provides logic control for the transmitter 140 and other electronic components. The device is powered by batteries 170.

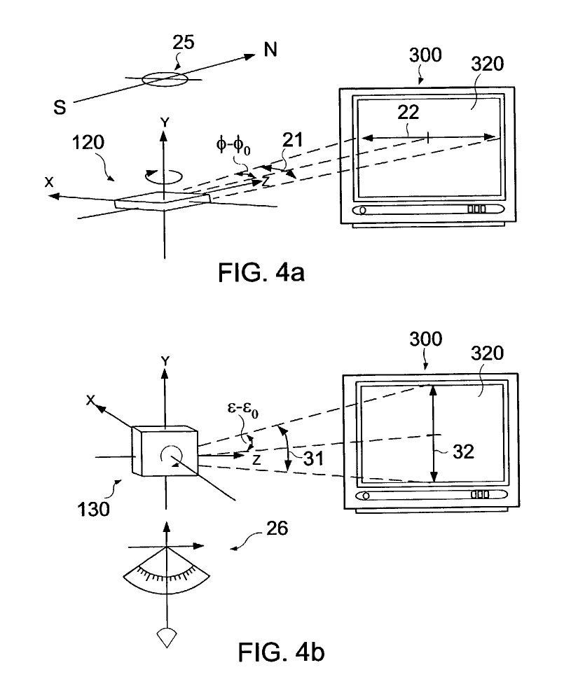

The orientation sensors' mechanisms are shown in FIGS. 4a and 4b. The orientation sensor demonstrated in FIG. 4a is a magnetic field sensor, whereas the one in FIG. 4b is an accelerometer sensor. However, the orientation detection may not be limited to these types of sensors. Other sensors, for example, a gyro sensor, can also be used in the pointing control system. In FIG. 4a, a two-axis magnetic field sensor 120 is used to detect the device's orientation relative to the direction of the earth's magnetic field 25. The sensor contains two magnetic field detectors which are arranged orthogonal to each other. The sensor is mounted on the device's circuit board so that the two magnetic field detectors are laid on the x-z plane as shown in the picture. The azimuth angle φ between the device's heading direction and the earth's North Pole direction can be calculated from the sensor's x and z output: φ=arc tan(x/z). When the user performs calibration, the device records the azimuth angle φ₀ as the reference angle as the user points the device to center of the screen. When the device is rotated about the y-axis and the pointing direction is moved away from screen's center, the azimuth angle difference from the reference angle is φ−φ_{0.} This difference is interpreted by the display control unit as the degree of the pointer's horizontal departure from the screen center. The amount by which the pointer moves horizontally (22) can be adjusted in the display control unit proportionally to the change in the pointer's azimuth angle 21.

The orientation sensor 130 uses a similar method to detect the device's inclination angle. The sensor could be an accelerometer or another orientation sensor that can sense the device's heading change in the y-z plane. An accelerometer sensor which can detect static acceleration is described in detail here. The accelerometer sensor 130 contains two orthogonally arranged acceleration detectors. The sensor is mounted perpendicular to the circuit board's plane so that one detector in the sensor detects y-axis acceleration and the other detects z-axis acceleration. Earth's gravity 26 exerts a static acceleration on these detectors. When the device is placed on a horizontal level, the accelerometer's z-axis detector outputs zero acceleration, while the y-axis outputs the maximum acceleration (1 g). If the device is rotated about the x-axis, the z and y channel outputs of the sensor are changed according to the inclination angle. The inclination angle E thus can be calculated: ε=arc tan(z/y). During the calibration, the device's inclination angle to the screen center ε₀ is recorded and stored as a reference angle. Any inclination angles sampled thereafter is compared with this reference angle by determining the offset, ε−ε₀. This difference is interpreted by the display control unit as a degree of the pointer's departure from the screen's center in the vertical direction. The amount by which the pointer moves vertically (32) can be adjusted in the display control unit proportionally to the change in the pointer's inclination angle 31.

For a simplified version, a one-axis accelerometer sensor can be used. In such a case, the acceleration detector is mounted along the device's z-axis. The inclination angle ε thus can be calculated: ε=arc sin(z).

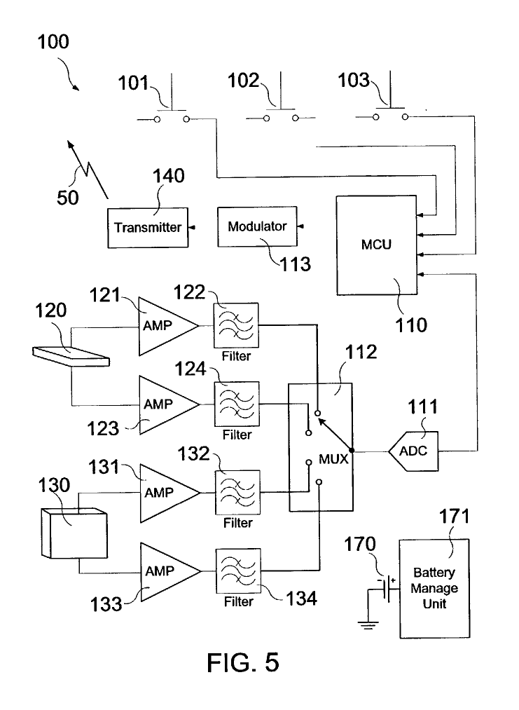

FIG. 5 is the functional block diagram of the handheld pointing device. The signal conditioning circuit for sensor 120 consists of two amplifiers 121, 123 and two low pass filters 122, 124. Because we are interested in the static position and low frequency movement of the device, the high frequency noises of the amplified x-axis and y-axis signals are filtered in order to get a higher resolution of the azimuth angle changes. Two amplifiers 131, 133 and two low pass filters 132, 134 are for conditioning the sensor 130 output's x-axis and z-axis signals. We are interested in the sensor's static output relative to earth's constant gravity. Therefore, the high frequency noises of the signals are also filtered in order to get a higher resolution of the inclination angle changes. The conditioned signals from sensors 120 and 130 are then sent to an analog-to-digital converter (ADC) 111 by an analog multiplexer 112. The digitized sensors data are then sent to a microcontroller (MCU) 110 for further signal processing. Some variations of the orientation sensor convert the analog signal internally to a digital or time period-based signal. In those cases, the signals can be directly sampled by the microcontroller without an ADC chip. The MCU 110 computes the azimuth and inclination angles. Buttons 101, 102, and 103 produce activity signals that are sampled by MCU 100. The sensor orientation data and buttons activities are coded in such a way that the display control unit can decode them later. The encoded data is passed to a modulator 113 to modulate a carrier frequency for transmission. The transmitter 140 emits the modulated signal 50 to the display control unit 200. The circuit is powered by batteries 170. A battery manager unit 171 conditions the voltage for all components of the circuit. The MCU 110 constantly monitors the changes of sensor outputs. If the sensor outputs are not changed for a period, the MCU interprets the device as not been used. The MCU instructs the battery manager unit 171 to shut down the battery power supply to the transmitter and other components in order to save power consumption during the idle stage.

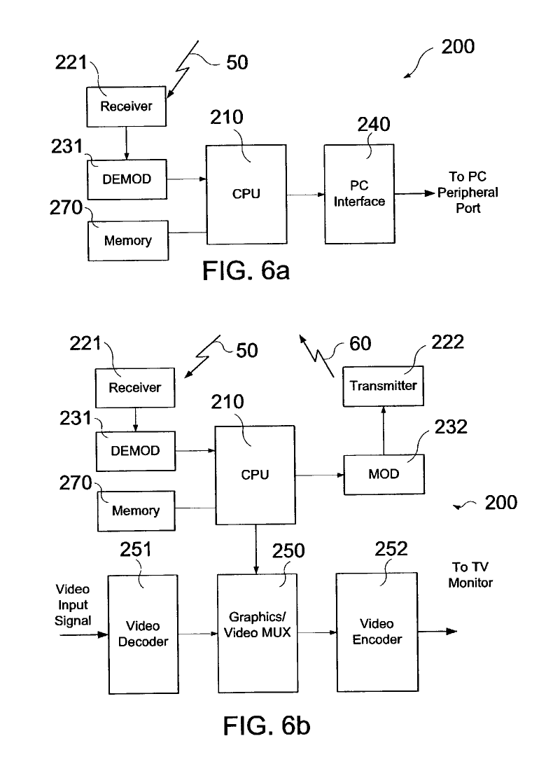

FIG. 6a and FIG. 6b show the functional block diagrams of display control unit 200 for a computer and a television set, respectively. A central process unit (CPU) 210, a receiver 221, a demodulator 231, and a memory module 270 are common for both cases. The transmitted signal 50 from the pointing device, which includes handheld device orientation and user selection activities, is intercepted by the receiver module 221. After being demodulated by a demodulator 231, the pointing device data is sent to CPU 210 for further processing. The CPU compares the device's azimuth and inclination angle data with the reference angles, which are sampled and stored in the memory module 270 during the calibration procedure. The difference angles calculated are translated into screen coordinates and the target device is instructed to move the pointer to the new location. The interface components of the display control unit are different for each control target. In FIG. 6a, a computer peripheral interface module is used to connect to a computer port. The pointer coordinates are sent to the computer and, by the computer's processor and video card, the pointer on the screen is moved to the corresponding location. The button activities are also sent to the computer though this interface and trigger certain actions for the computer.

FIG. 6b demonstrates the display control interfaces to a television. The input video signal, which may come from other home entertainment devices such as digital TV set-top boxes, DVD players, etc., is decoded by a video decoder 251 frame by frame. A new pointer image is drawn at the coordinate calculated by CPU 210. The pointer image, along with menus and other control item images pre-stored in the memory module 270, are sent to a graphic-video multiplexer 250 to superimpose onto a video frame. The composite video frame is then encoded by a video encoder 252 and sent to the television for display. The process is about 30 frames per second. As the result, a pointer is moved on top of the video following the handheld device's pointing direction. If the CPU 210 senses a button click activity while the pointer is moved on top a menu or a controllable item, it sends a command to a transmitter 222 through a modulator 232. The modulated transmission signal 60 is forwarded to the command delivery unit 300 for controlling the television and other home entertainment equipment.

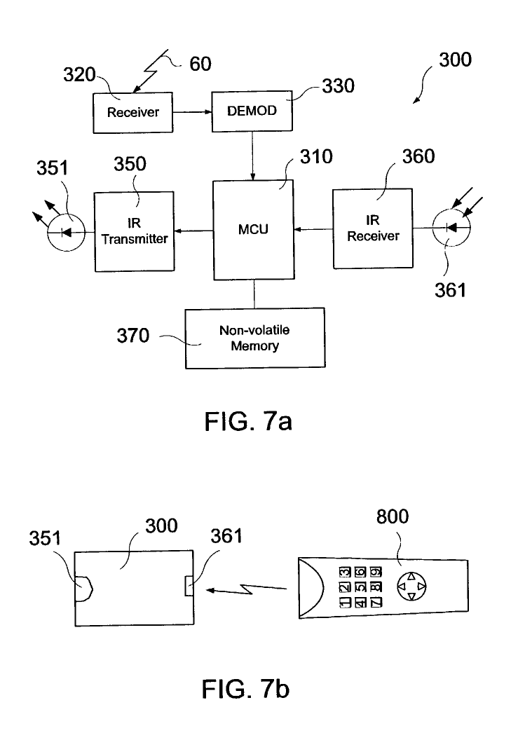

FIG. 7a is the functional block diagram of command delivery unit 300. A receiver 320 intercepts the transmitted signal from the display control unit 200. The signal is sent to a microcontroller (MCU) 310 after demodulation by a demodulator 330. In the command delivery unit, there is a non-volatile memory module which stores all the control command codes for varieties of home entertainment equipments. These command codes can preset by the vendor or stored by the user during programming or training procedures. The command codes are stored in such way that each command is coupled with an identification number (key). The arriving signal from the display control unit is served as the key so that MCU 310 can look up the key's record in memory and fetch the corresponding command code. For example, if the pointer is moved on top of a VCR play button on the screen and user clicks the selection button, the display control unit sends a value equal to 100 to the command delivery unit. By looking up the key value 100 in the memory module, the MCU 310 fetches the pre-stored VCR play command code. The command code is sent to an infrared transmitter 350 to drive an infrared emitter 351. The infrared-carried command code is then sent to the home entertainment equipment, in this case a VCR, to control their functions.

FIG. 7b demonstrates the programming (training) procedure of the command delivery unit. When the user adds new home entertainment equipment, he/she can program the command delivery unit to learn commands for the equipment. By moving the pointer on the screen and selecting a new control item, the control display unit prompts the user to train the command delivery unit with the equipment's original remote control. The control display unit also sends an identification key value to the command delivery unit. At this moment, the user can point the equipment's original remote control 800 to the command deliver unit 300 and push a corresponding remote control button. An infrared signal is sent to an infrared sensor 361 on the command delivery unit. On FIG. 7a, the infrared signal is converted to electronic code by the infrared receiver 360. This code is stored with the identification key value into the memory module 370. The code stored is retrieved later by the command delivery unit to control the equipment. Because the infrared command received by the home entertainment equipment received is exactly the same as their original native code, any infrared controlled equipment can be controlled by the command delivery unit.

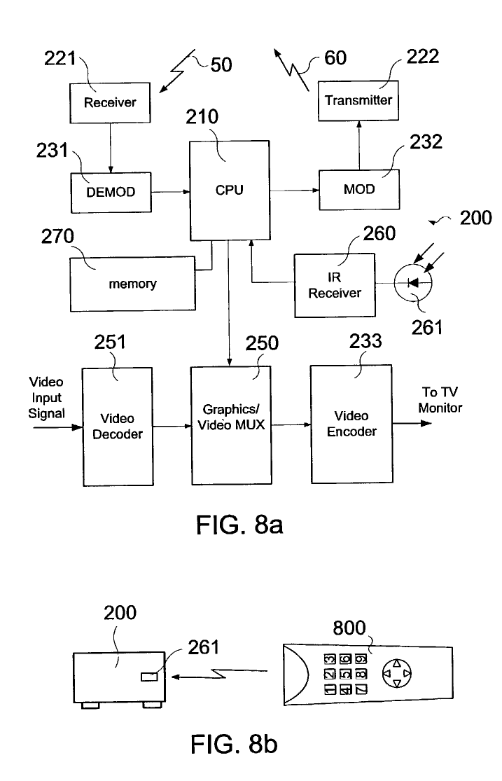

In an alternative implementation, the control command codes can be stored in the display control unit instead of the command delivery unit as shown in FIG. 8a. In this case, an infrared receiver 260 and an infrared sensor 267 are added to the unit. During the programming procedure shown in FIG. 8b, the home entertainment equipment's original remote control 800 is pointed to the display control unit 200. The infrared signal is received by the infrared sensor 261 and infrared receiver 260, and the command codes are stored in the memory module 270 with an identification key value. During control session, the MCU retrieves the command code using a key value according to the user's selection on the screen. The command code is sent to the command delivery unit through the modulator 232 and transmitter 222. The command delivery unit in this case simply forwards the command to the target home entertainment equipment.

1. A pointing control system, comprising:
a battery-powered handheld pointing device to enable the user to move the position of a pointer or a cursor presented on a display device by changing said handheld pointing device's heading direction without using any reference objects, and
a pointer display control unit that communicates with the handheld device, and interfaces a computer to control a pointer on the screen location and generate a control signal to notify the computer that a selectable identifier on display has been selected; and/or interfaces to a television to generate a replaceable image as a cursor and a set of selectable identifier images, which are superimposed onto the video signal and displayed on the screen.

2. The pointing control system of claim 1, wherein the handheld pointing device comprises a sensor unit and wherein the sensor unit comprises a set of orthogonally arranged spatial orientation sensors in which magnetic field sensors or gyro sensors are utilized for detecting said device's yaw (azimuth) angle and a set of accelerometer sensors or gyro sensors are utilized for detecting said device's pitch (inclination) angle, so that said device's device orientation in three-dimensional space can be determined without using any other reference sources in the local environment.

3. The pointing control system of claim 1, wherein the handheld pointing device comprises a selection unit wherein the selection unit comprises a set of buttons which allow the user to select a command identifier on the display, to calibrate the pointer location, and to control pointer appearance status, and of a circuitry to collect said buttons' activities.

4. The pointing control system of claim 1, wherein the handheld pointing device comprises a circuitry to collect, condition, process, and code the data from the sensor unit and the data from the selection unit.

5. The pointing control system of claim 1, wherein the handheld pointing device comprises a battery management unit which controls and conditions the power supply, and a method to monitor the sensors' activities and notify the battery management unit to shut down components' power supplies in order to reduce power consumption during the handheld pointing device's idle stage.

6. The pointing control system of claim 1, wherein the handheld pointing device comprises a wireless transmission unit to transmit orientation data and user selection activity data to the pointer display control unit remotely.

7. The pointing control system of claim 1, wherein the pointer display control unit comprises a wireless receiver to intercept the orientation data and user selection activity data transmitted from the handheld pointing device.

8. The pointing control system of claim 1, wherein the pointer display control unit comprises a microprocessor, a memory module, a control circuitry, and supporting software to analyze and translate the handheld pointing device's orientation data to coordinates for the pointer on the target screen, and to calibrate the pointing direction of the handheld pointing device.

9. The pointing control system of claim 1, wherein the pointer display control unit comprises a circuitry to interface at least one of the target devices: (a) a computer system, to control the cursor's location on the screen in response to received data describing the handheld pointing device's spatial orientation, and to activate a computer function in response to user selection activities; (b) a television set, to draw a pointer image at a television screen location in response to received data describing the handheld pointing device's spatial orientation, and to superimpose the pointer image onto the to television video display.

10. The control system of claim 9, wherein the pointer display control unit, in case of interfacing a television set, comprises a method to draw selectable identifiers on the television screen and a method detect if a selectable identifier on screen has been selected in response to the user's clicking activity on the handheld device buttons.

11. Command delivery apparatus, comprising:
a recorder unit to record and store remote control command codes for target devices, which can be one or more of the home entertainment equipments including, but not limited to, a conventional television set, a digital television set, a digital TV set-top box, a satellite TV set-to box, a cable TV set-top box, a DVD player, a CD player, a VCR, a DVHS recorder, a laser disc player, a VCD player, and an audio amplifier/transceiver,
a base member, which is associated with a pointing system, to transmit the identity of a user-selected on-screen identifier or command code to the remote member, and
a remote member, which faces the target devices, to receive the data from the base member and forward the infrared control command to target devices.

12. The command delivery apparatus of claim 11, wherein the recorder unit comprises an infrared receiver to intercept the remote control command codes from the target device's infrared remote control, a memory module to store the intercepted remote control command codes and user-selected identities, a circuitry to couple with the base member or remote member of said command delivery apparatus, and a method to store or retrieve the command code paired with a user-selected screen identity.

13. The command delivery apparatus of claim 11, wherein the recorder unit comprises software to prompt the user to activate a conventional remote control, to control the infrared receiver, to verify and process the received infrared data, and to store and archive the command codes.

14. The command delivery apparatus of claim 11, wherein the base member comprises a circuitry to interface a pointing control system and a wireless transmitter to transmit a user-selected screen identity or a control command code stored in the recorder unit to the remote member when the user applies a selection activity.

15. The command delivery apparatus of claim 11, wherein the remote member comprises a wireless receiver to intercept data from the base member, and an infrared transmitter to forward a selected command control code to the target device.
